(19) United States
(12) Patent Application Publication
(10) Pub. No.: US 2003/0099274 A1
(43) Pub. Date: May 29, 2003

(54) Laser module

(75) Inventor: William B. Joyce, Basking Ridge, NJ (US)

Correspondence Address: LESTER H. BIRNBAUM, 6308 SAUTERNE DRIVE, MACUNGIE, PA, 18062, US

(73) Assignee: Agere Systems Optoelectronics Guardian Corp.

(21) Appl. No.: 09/996,220

(22) Filed: Nov. 28, 2001

(51) Int. Cl. H01S 3/04; H01S 3/08

(52) U.S. Cl. 372/108; 372/36

(57) ABSTRACT

A laser module wherein a platform supports an optical fiber component having a cantilever portion. The cantilever portion has a length sufficient to provide alignment of the optical fiber component with a laser. Alignment may be, for example, in an X-direction, Y-direction, or both. The platform may be housed in a compliant case. Also disclosed is a method of monitoring the coupling efficiency between, and the alignment of, the laser and optical fiber component.

### FIELD OF THE INVENTION

The invention relates to semiconductor lasers, and more particularly to mounting of lasers within a module.

### BACKGROUND OF THE INVENTION

A laser module includes a laser device surrounded by a protective case. A typical module design is depicted in FIG. 1. A laser 102 is positioned on a platform 104 within a case 106. A clip 108 is situated on platform 104 proximate to laser 102. Clip 108 supports an optical fiber component 116 which is aligned with laser 102. Optical fiber component 116 typically comprises an optical fiber 110 surrounded by a sleeve 114. Clip 108 is designed to allow alignment in the X, Y and Z-directions wherein the X-Y plane is perpendicular to the longitudinal direction of optical fiber component 116. Optical fiber component 116 extends outside of a case wall 112. Proper alignment of optical fiber component 116 with laser 102 is important for the performance of the device.

Prior art clips, or other optical fiber support components, have the capability of aligning the fiber relative to the laser at the platform level of integration. Thereafter, it is desirable for the clip to be stiff to defend the alignment against the stresses that arise from actions such as affixing the platform within a case. It has proven difficult to design a clip that is both stiff and yet adjustable in the X, Y, and Z-directions.

Typically the optical fiber is aligned with the laser prior to enclosure in the case. Subsequent testing, use and environmental conditions may cause misalignment. Conventional laser modules have achieved adjustability at the expense of stiffness. Unfortunately, the more flexible the clip is, the more likely misalignment may occur.

Accordingly, there is a need for a laser module with components having the rigidity necessary to protect against stresses that may cause misalignment, and flexibility to allow for accurate alignment.

### SUMMARY OF THE INVENTION

The present invention provides a laser module in which a conventional clip used to support an optical fiber component may not be necessary. Embodiments of the invention balance adjustability with protection against stresses by shifting alignment from the clip to a cantilever-type optical fiber component. Embodiments of the invention provide a laser module wherein a platform supports the optical fiber component. The platform includes a pedestal on which the optical fiber component may rest such that the component extends a sufficient amount to provide a cantilever portion. The cantilever portion allows movement of the component for alignment of the fiber component with a laser. Thus, a clip which traditionally facilitates alignment, may not be needed. The cantilever portion has a length sufficient to provide alignment of the optical fiber component with the laser. Alignment may be, for example, in an X-direction, Y-direction, or both.

By providing sufficient support for the optical fiber component, the platform and laser may be enclosed in a compliant case.

Embodiments of the invention further comprise a method of monitoring the coupling efficiency between, and relative position of, the laser and the optical fiber component.

### DESCRIPTION OF THE DRAWINGS

The invention is best understood from the following detailed description when read with the accompanying drawings.

FIG. 1 depicts a cross-sectional view of a prior art laser module.

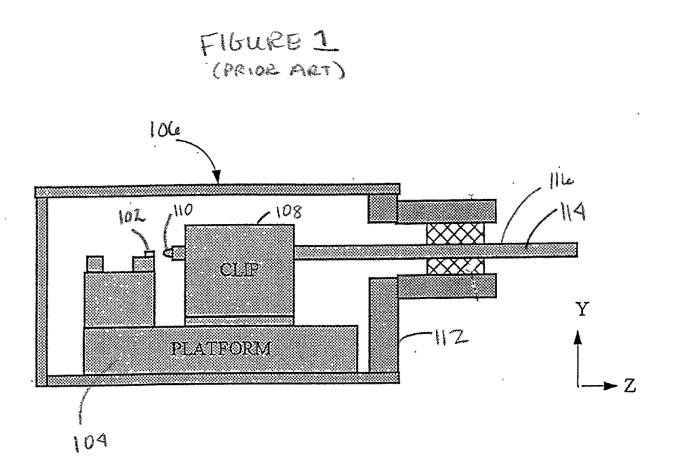

FIG. 2 depicts a cross-sectional view of a laser module according to a first illustrative embodiment of the invention.

FIG. 3 depicts a cross-sectional view of a laser module portion according to a second illustrative embodiment of the invention.

FIGS. 4A-C depict cross-sectional views of a groove according to illustrative embodiments of the invention.

### DETAILED DESCRIPTION OF THE INVENTION

Embodiments of the invention may provide both adjustability and stiffness by combining a cantilever for fine-tuning the alignment with a rigid pedestal. The rigid pedestal may facilitate an initial course alignment and, subsequently, may isolate the fine-tuned cantilever alignment from misaligning influences.

In the present invention an optical fiber component is supported by a portion of a platform, referred to herein as a “pedestal”. The optical fiber component extends from the platform a sufficient amount to provide a cantilever. The cantilever may be used to facilitate alignment of the optical fiber component with a laser. Although a conventional clip or the like may not be necessary, it still may be incorporated in embodiments of the invention.

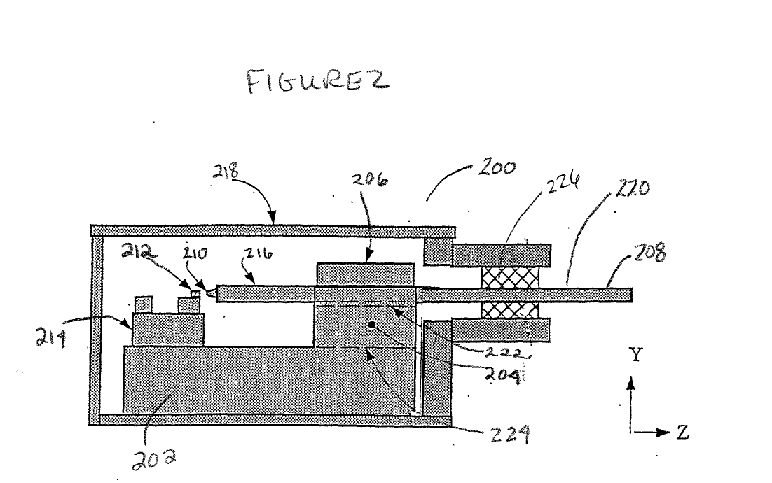

FIG. 2 depicts a laser module 200 according to an illustrative embodiment of the invention. Platform 202 has a laser stack 214 on top of it. Laser stack 214 may include one or more components, and supports laser 212. Platform 202 includes a pedestal 204 spaced from laser stack 214. An optical fiber component 220, which may include for example, an optical fiber 210 within a sleeve 208, rests on pedestal 204. A pedestal cap 206 may be employed to hold optical fiber component 220 in place on pedestal 204. Optical fiber component 220 has a cantilever portion 216 which is the portion that protrudes from pedestal 204 toward laser 212.

Cantilever portion 216 may be angled with respect to the remainder of optical fiber component 220 to provide alignment of optical fiber 210 with laser 212. In an illustrative example, alignment is in an X-direction, Y-direction, or both. As used herein, the X and Y-directions define a plane that is substantially perpendicular to the longitudinal direction of optical fiber 210, and a Z-direction which is in the longitudinal direction of optical fiber 210.

Embodiments of the invention may add additional degrees of freedom to that which is present in the prior art, and therefore, may reduce problems associated with conventional clips. According to embodiments of the invention the X and Y-alignment are shifted from the clip, or other support structure, to a cantilever. The clip can now be rugged and stiff, as the cantilever provides for fine-tuning of laser and fiber alignment.

In the illustrative embodiment of the invention depicted in FIG. 2, the platform takes on a L-shape, wherein the base of the L functions as a pedestal for optical fiber component 220. In addition to being stiff, the pedestal has a relatively low influence coefficient for transforming any residual Z-compliance of the pedestal into Y-motion of the fiber tip. The influence coefficient is the ratio of the Y-motion of the focal point of fiber 210, to the Z-motion of pedestal 204 arising from a Z-force in sleeve 208. The Z-force may arise, for example, from hermetic solder 226, or other fastening means. Prior art clips typically have high influence coefficients, generally on the order of 0.7. In an illustrative embodiment of the invention, the cantilever portion of the optical fiber component has an influence coefficient of less than about 0.2 with an exemplary value of less than about 0.1.

Optical fiber component 220 may be affixed to pedestal 204 by any of various means, including, for example, soldering or welding. As shown in FIG. 2, pedestal cap 206, preferably welded to pedestal 204, may be used to position optical fiber component 220 on pedestal 204. A groove or channel 222 may be incorporated into cap 206 and/or pedestal 204 to facilitate positioning of optical fiber component 220.

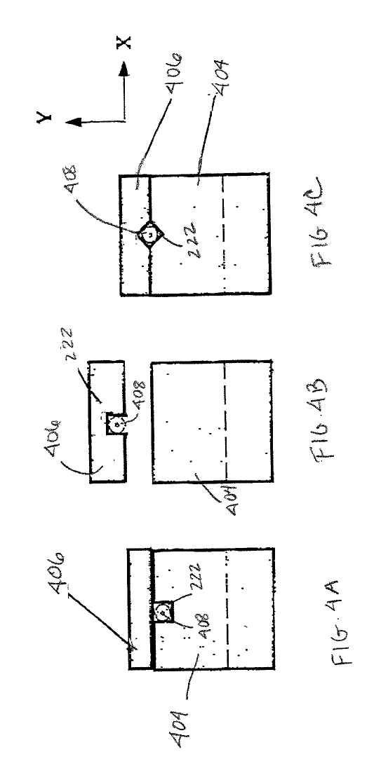

FIGS. 4A-C show illustrative positions of groove 222. FIGS. 4A, B and C depict groove 222 in pedestal 404, cap 406 and in both pedestal 404 and cap 406, respectively. Optical fiber component 408 is aligned in the Z-direction when it is positioned in groove 222.

Groove 222 may be any shape that accommodates optical fiber component 220, but is preferably rectangularly, V or U-shaped. The cap-to-pedestal weld design depicted in FIG. 2 allows fiber 210 and cap 206 to be attached, alignment to be performed either before or after the pedestal 204 is secured within a case 218. The Z-separation between the fiber and the laser is set when the sleeve is affixed to the pedestal. Alternately, the Z-separation is set by affixing the laser stack to the platform after the sleeve is affixed to the pedestal. Finally, fine X and Y-alignments are done by bending the cantilever.

The stiff platform may be placed into a relatively compliant case with reduced risk of misalignment from external factors as compared to prior art designs. If, in addition, the platform is sufficiently narrower in the X-direction and/or shorter in the Z-direction than the case, then torsion of the case about the Z-axis, as results, for example, from affixing the case at four corners to an imperfectly flat plate, will not be transmitted into platform torsion and laser-fiber misalignment.

Embodiments of the inventive pedestal may have a relatively low influence coefficient for transforming any residual Z-compliance of the pedestal into Y-motion of the fiber tip. This is usually caused by internal stress along the axis of the sleeve because the sleeve is attached at two points and is not thermal-expansion matched perfectly with the case, and because the case is deformed slightly when the case is affixed to a plate. This may move the fiber tip slightly in the Z-direction relative to the laser, but the coupling of light from the laser into the fiber is somewhat tolerant to Z-motion. However, it is not very tolerant to Y-motion. Some prior art designs deform in such a way that Z-force in the sleeve causes Y-motion of the fiber tip as well as Z-motion relative to the laser. Advantageously embodiments of the invention are relatively free from this Y-response.

In an illustrative embodiment of the invention the ratio of the cantilever sleeve length to the sleeve diameter is in the range of about 1 to about 10, with an exemplary range of about 2 to about 4.

Platform 202, including pedestal 204 and cap 206, may be formed from the same or different types of materials, and may contain separate parts affixed to one another. Some or all of platform 202 may be formed from a single piece of material. For example, platform 202, including pedestal 204, may be formed from a single piece of material. Materials may be chosen so that the coefficient of thermal expansion of pedestal 204 corresponds with that of laser stack 214 so that alignment of optical fiber 210 and laser 212 may be substantially maintained during temperature changes. The illustrative embodiment in FIG. 2 shows a change of materials at interface 224, however, other configurations are within the spirit and scope of the invention.

Optical fiber component 220 may be affixed to pedestal 204 by any method compatible with the materials and the device operation. Exemplary methods include welding and soldering.

A case 218 may be provided around platform 202, laser stack 214 and laser 212 for protection. Because optical fiber component 220 is stabilized by pedestal 204, case 218 may be formed of a compliant material. Illustrative examples of case materials include metals such as CuW, alumina and metal alloys such as KOVAR®, a registered trademark of CRS Holding, Inc., a subsidiary of Carpenter Technology Corporation. Platform 202 and sleeve 208 may also be made of these materials.

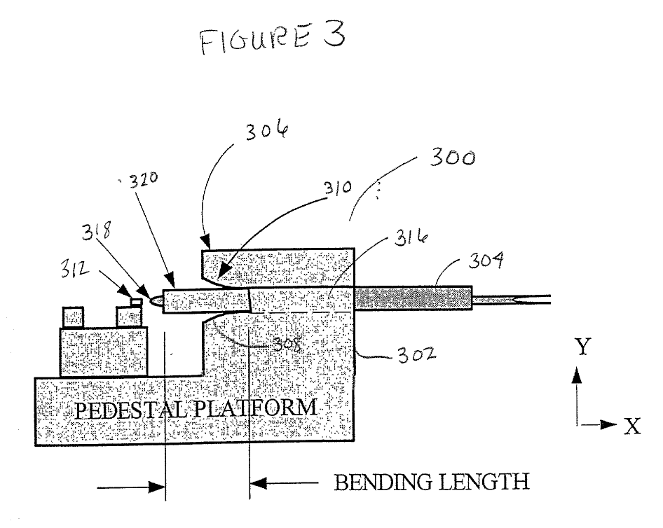

FIG. 3 depicts a cross-sectional view of a laser module portion 300 according to a further embodiment of the invention. Laser module portion 300 has a pedestal 302 to support an optical fiber component 304. Optical fiber component 304, may include an optical fiber 318 disposed with a sleeve 320. Laser module portion 300 may have a pedestal cap 306 to secure optical fiber component 304 to pedestal 302. In the embodiment depicted in FIG. 3, movement of optical fiber component 304 is facilitated by flared portions 308, 310 of pedestal 302 and cap 306, respectively, to ease bending of component 304 around pedestal 302 and cap 306. Flared portions 308, 310 are at a pedestal side proximate to laser 312 and may be, for example, curved or angled. Flared portions 308, 310 may facilitate Y-motion, X-motion or both. Flared portions 308, 310 may diminish constriction of optical fiber component 304 due to bending around a pedestal corner having a right angle. FIG. 3 shows a bending length which is the length of optical fiber component 304 that may be bent at an angle to the remainder of component 304, or as referred to previously as the cantilever portion of component 304. The cantilever is preferably no longer than necessary for alignment purposes, but may be any length sufficient for the fiber to maintain its aligned position, without undue sensitivity to extraneous influences. In an illustrative embodiment, the bending length is sufficient to provide motion of up to about 10 μm. In a further embodiment, the bending length is sufficient to provide motion of up to about 200 μm. The motion may be in the X-direction, Y-direction, or both.

A cantilever module as described herein may be designed to permit selective vibration, primarily by having a lower resonant frequency than other components of the module, such as the platform, case and laser stack, and/or by having a geometry that can be vibrated in the XY-plane, YZ-plane or both, according to how the platform or case is vibrated. Alternatively, or additionally, the XZ and YZ-vibrations can be separately addressed by splitting the XZ and YZ-resonant frequencies. Such splitting may be achieved by breaking the rotational symmetry of the sleeve about its Z-axis. This may be accomplished, for example, by using a sleeve having an elliptical cross-section or other shape not uniformly symmetrical around the optical fiber.

In a further embodiment the splitting may be achieved by placing the optical fiber component in a groove, such as shown, for example by part 316 in FIG. 3. In an illustrative example, groove 316 does not have a uniform cross-section throughout the length of the portion of optical fiber component 304 supported at groove 316. For example, groove 316 may allow different degrees of movement of optical fiber component 304 in the XZ-plane than the YZ-plane, for a limited lateral distance along groove 316.

It is known that mechanical stress may cause alignment loss during manufacture and system life. A cantilever module may acquire stress when its cantilever is plastically deformed to achieve fiber-to-laser alignment. The design described in the preceding paragraph permits tailored mechanical stress relief to be delivered directly to the stressed area by high-frequency vibration.

Harmonic frequencies of the light intensity variations caused by mechanical vibration of the optical fiber component, may be used to monitor the position of the optical fiber component, or more particularly to the optical fiber, relative to the laser. These harmonic frequencies may also be used to monitor the coupling efficiency. When the laser is operating, the fundamental frequency (zeroth harmonic) and harmonic frequencies of the light intensity variations from the cantilever portion of the optical fiber will reveal the X and Y-positions of the fiber relative to the laser, the fundamental frequency being the mechanical vibration frequency of the cantilever sleeve. For example, when the fiber is perfectly aligned in the Y-direction and the sleeve is vibrating in the YZ-plane, the fundamental frequency will be at a minimum with respect to the first harmonic. When the alignment is at the inflection point of the Gaussian coupling efficiency, it will be at a relative maximum.

While the invention has been described by illustrative embodiments, additional advantages and modifications will occur to those skilled in the art. Therefore, the invention in its broader aspects is not limited to specific details shown and described herein. Modifications, for example, to types of platform, sleeve and case materials, and pedestal configuration, may be made without departing from the spirit and scope of the invention. Accordingly, it is intended that the invention not be limited to the specific illustrative embodiments but be interpreted within the full spirit and scope of the appended claims and their equivalents.

Claimed is:

1. A laser module comprising:
a platform to support a laser; and
an optical fiber component having a cantilever portion;
wherein the platform includes a pedestal to support the cantilever portion; and
wherein the cantilever portion has a length sufficient to provide motion to align the optical fiber component with the laser.

2. The laser module of claim 1 wherein the cantilever portion has a length sufficient to provide motion of up to about 200 μm.

3. The laser module of claim 1 wherein the cantilever portion has an influence coefficient of less than about 0.2.

4. The laser module of claim 1 wherein the ratio of the cantilever portion length to diameter is in the range of about 1 to about 10.

5. The laser module of claim 1 wherein at least one laser module component is flared to facilitate bending of the optical fiber component.

6. The laser module of claim 1 wherein the platform comprises more than one material type.

7. The laser module of claim 1 further comprising a groove within which the optical fiber component is positioned, and wherein the groove is disposed in a laser module portion selected from the group consisting of the pedestal, a cap and both the pedestal and the cap.

8. The laser module of claim 1 further comprising a case surrounding the platform, laser and a portion of the optical fiber component, wherein the case is compliant.

9. The laser module of claim 1 further comprising a case surrounding the platform, laser and a portion of the optical fiber component, wherein the case comprises a material selected from the group consisting of CuW, metal alloys and alumina.

10. The laser module of claim 1 wherein the platform comprises one or more materials selected from the group consisting of CuW, metal alloys and alumina.

11. The laser module of claim 1 wherein the optical fiber component comprises an optical fiber surrounded by a sleeve, and the sleeve is non-symmetrical around the optical fiber.

12. The laser module of claim 1 wherein the optical fiber component comprises an optical fiber surrounded by a sleeve, and wherein the sleeve has an elliptical cross-section.

13. The laser module of claim 1 wherein XZ and YZ- resonant frequencies of the cantilever portions are split.

14. The laser module of claim 1 wherein the cantilever portion has a lower resonant frequency than other module components.

15. The laser module of claim 14 wherein the other module components are selected from the group consisting of platform, case and laser.

16. A method of monitoring coupling efficiency of an optical fiber to a laser, the method comprising:
measuring harmonic frequencies of the light intensity from the laser to determine X and Y-positions of the optical fiber relative to the laser.

17. A method of monitoring position of an optical fiber relative to a laser comprising:
measuring harmonic frequencies of the light intensity from the laser to determine X and Y-positions of the optical fiber relative to the laser.

18. A semiconductor device comprising a laser module according to claim 1.
